(19) United States
(12) Patent Application Publication
(10) Pub. No.: US 2007/0248284 A1
(43) Pub. Date: Oct. 25, 2007

(54) Device and Method of Downscaling and Blending Two High Resolution Images

(75) Inventors: Johannes Arnoldus Cornelis Bernsen, Eindhoven (NL); Robert Peters, Doetinchem (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,506

(22) PCT Filed: Jun. 9, 2005
(86) PCT No.: PCT/IB05/51902

§ 371 Date: Dec. 13, 2006

(30) Foreign Application Priority Data
Jun. 21, 2004 (EP) 04102829.1

(51) Int. Cl. G06K 9/00

(52) U.S. Cl. 382/298

(57) ABSTRACT

The present invention relates to the field of downscaling and blending of two high resolution images, and particularly to a device and a method allowing for downscaling and blending of a HD JPEG background image and a HD bitmap image, which is overlaid on the JPEG background image. The device comprises means for downscaling the background image by a pre-determined factor n1, n2, . . . n_{N}; means for uncompressing the downscaled background image and the high-resolution bitmap image; means for dividing the uncompressed high-resolution bitmap image into blocks of n1×n2× . . . ×nN pixels, whereby the size of each block correspond to the size of each pixel of the downscaled background image; and, means (16) for blending each of the blocks of the uncompressed high-resolution bitmap image with each of the pixels of the downscaled background image and thus producing a blended image.

### BACKGROUND OF THE INVENTION

1. Field of the Invention

The present patent application relates to the field of downscaling and blending of two high resolution images, and particularly to a device allowing for downscaling and blending of a HD JPEG background image and a HD bitmap image, which is overlaid on the JPEG background image, as well as a method for such downscaling and blending.

2. Description of the Related Art

Pictures in Super Audio Compact Disk (Super Audio CD) format consist of two parts: a background image in JPEG format with 3×8 bit e.g. Red-Green-Blue (RGB) per pixel; and, a bitmap image with 2 bit per pixel, which is overlaid on the JPEG image. Each pixel within the bitmap image has a transparency value which can vary from pixel to pixel ranging from 0-100%, i.e. the degree of opacity of the bitmap pixels with 0% representing fully opaque and 100% representing transparent. Usually, the bitmap image has an associated look-up table (LUT) from each of the four possible values per pixel to a set of 3×8 bit RGB values. The bitmap image contains extra information, such as text in different languages, and more than one bitmap image can be blended with the same JPEG background image. Therefore, it is advantageous to store the background JPEG image and bitmap images separately and let the Super Audio CD player blend the two when required.

Both the JPEG background image and the bitmap images are of High Definition (HD) format, 1920×1080 pixels. Some Super Audio CD players have a High Definition Television (HDTV) output, but most players have a Standard Definition Television (SDTV) output. Therefore, the Super Audio CD players have to downscale the HD background image and bitmap images to a SD size, such as 720×480 for NTSC (National Television System Committee) or 720×576 for PAL (Phase Alternation Line).

One prior art approach is shown in WO 00/45362, which discloses an automatic graphics adaptation to video mode for HDTV. The automatic graphics adaptation combines a single format bit mapped graphic image automatically with different digital video modes, such as HDTV and SDTV. The bit mapped graphical image is remapped from a 1×1 pixel to a corresponding 2×2 set of Digital Television System (DTV) pixels when the current display mode is an HDTV mode. The bit mapped graphical image is remapped from a pixel to a corresponding DTV pixel when the current display mode is an SDTV mode. And, the remapped bit mapped graphical image is superimposed on to the current display mode.

However, this prior art approach does not include any scaling and the bit mapped graphical image is provided in an SDTV mode instead of an HDTV mode.

Another prior art approach in Super Audio CD players having a SDTV output to downscale and render images stored in HD compressed formats is as follows:

uncompressing the JPEG background image, which yields a 1920×1080×3×8 bit RGB image;

uncompressing the bitmap image, which yields a 1920×1080×2 bit bitmap image;

blending the two images (output pixel=transparency×JPEG pixel+(1−transparency)×bitmap pixel); and,

downscaling the HD blended image to an SD image.

The first step in the above described example requires a lot of processing time and a lot of image memory. It is better to downscale the JPEG image using e.g. the Discrete Cosine Transform (DCT) which is known technology. For example, for downscaling by a factor 2, the DCT method ignores ¾ of all the high-frequency DCT coefficients and uses the remaining ¼ of the low-frequency DCT coefficients to render an image with half the original size. This way of downscaling produces excellent results. When using the DCT method of downscaling, the following steps are used:

downscaling the JPEG background image in the DCT domain by a factor 2 and uncompress the result, which yields a 960×540×3×8 bit RGB image;

uncompressing the bitmap image, which yields a 1920×1080×2 bit bitmap image;

downscaling the bitmap image by a factor 2, which yields a 960×540×2 bit bitmap image;

blending the two half-resolution images; and,

downscaling the blended half-resolution image further to SDTV size, such as 720×480 for NTSC or 720×576 for PAL.

When using the DCT method of downscaling, the processing requirements of the first step are reduced to only 25% of the requirements of the first step of the first above described example of downscaling. This also applies on the required image memory. Furthermore, the blending is in the DCT method done on images having ¼ of the number of pixels, which again is a reduction with 25% of the processing requirements of the first described example. Thus, clearly it is advantageous to downscale the JPEG background image in the DCT domain.

However, the bitmap image has pixels having a certain transparency ranging from 0-100%. When downscaling those pixels, it is necessary to know the values of the pixels of the JPEG background image, but these are not available in the right resolution when the above described DCT method is used.

### SUMMARY OF THE INVENTION

Accordingly, it is an object of the present invention to provide an improved device allowing for downscaling and blending of two high-resolution images.

This object is achieved through providing means for downscaling the background image by a predetermined factor n₁, n₂, . . . n_{N}; means for uncompressing the downscaled background image; means for uncompressing the high-resolution bitmap image; means for dividing the uncompressed high-resolution bitmap image into blocks of n₁×n₂× . . . ×n_{N} pixels, whereby the size of each block correspond to the size of each pixel of the downscaled background image; and, means for blending each of the blocks of the uncompressed high-resolution bitmap image with each of the pixels of the downscaled background image and thus producing a blended image.

Another object of the invention is to provide an improved method for downscaling and blending of two high-resolution images.

This object is achieved through a method comprising the steps of: downscaling the background image by a predetermined factor n₁, n₂, . . . n_{N}; uncompressing the downscaled background image; uncompressing the high-resolution bitmap image; dividing the uncompressed high-resolution bitmap image into blocks of n₁×n₂× . . . ×n_{N} pixels, whereby the size of each block correspond to the size of each pixel of the downscaled background image; and, blending each of the blocks of the uncompressed high-resolution bitmap image with each of the pixels of the downscaled background image and thus producing a blended image.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 discloses a schematic view of a Super Audio CD player device according to an embodiment of the invention;

FIG. 2 discloses a flowchart showing the inventive method steps of the preferred embodiment of the present invention;

FIG. 3 discloses an example of a look-up table showing the RGB values for each bitmap pixel value when the transparency is 0% or 100%;

FIG. 4 discloses another example of a look-up table showing the RGB values for each bitmap pixel value when the transparency is more than 0% or less than 100%.

### DETAILED DESCRIPTION OF THE PRESENTLY PREFERRED EMBODIMENTS

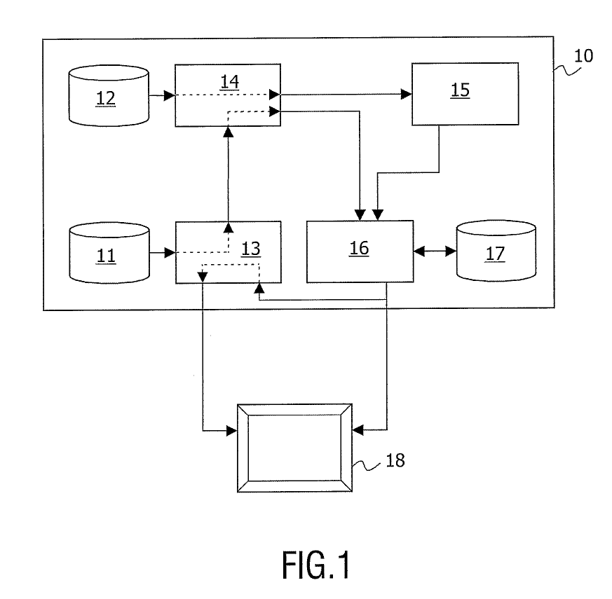

FIG. 1 is a conceptual diagram showing a basic constitution of a Super Audio CD player device 10 according to a preferred embodiment of the present invention. It should be understood that the device 10 shown in FIG. 1 only shows the parts which are necessary for the present invention, and that a Super Audio CD player device also comprises parts like a disc drive, audio processing etc. The player device 10 comprises in a preferred embodiment storing means 11, 12, such as memories, for storing a high-resolution compressed background image and a high-resolution compressed bitmap image. The high-resolution compressed background image, such as a JPEG background image, is preferably stored separately in a memory 11 and the high-resolution compressed bitmap image is preferably stored separately in another memory 12. Even though the two images are stored separately and shown in FIG. 1 to be stored in different memories 11, 12, the person skilled in the art realizes that these memories 11, 12 may be incorporated in the same physical hardware memory. The player device 10 further comprises means 14, such as a decoder, for uncompressing the background image and the bitmap image.

Further, the player device 10 comprises means 13 for downscaling, the background image by a predetermined factor n₁, n₂, . . . n_{N}, means 15 for dividing the uncompressed high-resolution bitmap image into blocks of n₁×n₂× . . . ×n_{N} pixels, whereby the size of each block correspond to the size of each pixel of the downscaled background image and means 16 for blending each of the blocks of the uncompressed high-resolution bitmap image with each of the pixels of the downscaled background image and thus producing a blended image. The player device 10 preferably also comprises at least one look-up table (LUT) 17, in which e.g. four possible values per pixel of the bitmap image maps to 4×8 bit RGB and T. This will be described in more detail below. The blended image is presented on a monitor 18. Preferably, the blended image is further downscaled in the scaler 13 to a desired size, such as 720×480 for NTSC or 720×576 for PAL, before being presented on the monitor 18.

The scaler 13, decoder 14, dividing means 15 and blending means 16 are shown in FIG. 1 as separate blocks. All these functions may just as well be incorporated in one and the same processor or two processors etc.

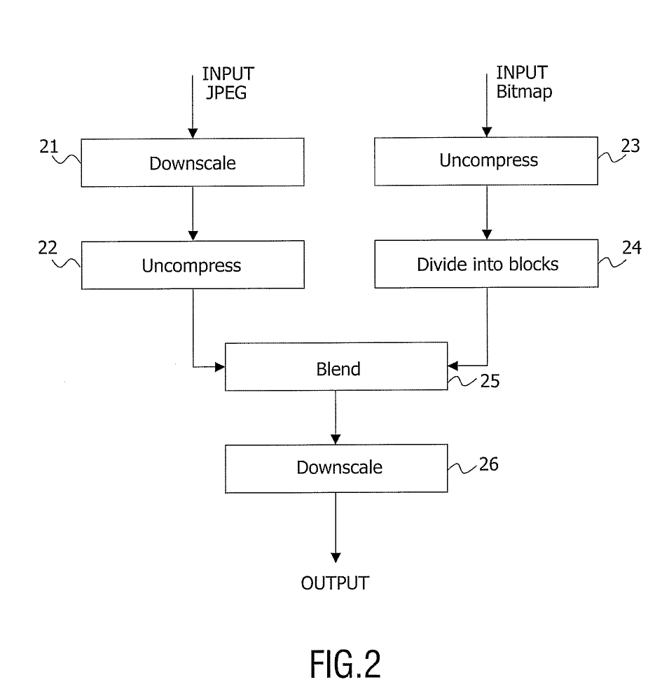

In the preferred embodiment of the present invention, the procedure for downscaling and blending a high-resolution compressed background image comprising pixels and a high-resolution compressed bitmap image comprising pixels, shown in FIG. 2, is as follows:

downscaling the compressed background image by a predetermined factor n₁, n₂, . . . n_{N} (step 21). In the preferred embodiment of the present invention, the high-resolution background image is a HD JPEG background image, which is downscaled in the DCT domain by a factor 2;

uncompressing the downscaled background image (step 22), which in the preferred embodiment yields a 960×540×3×8 bit RGB image;

uncompressing the high-resolution bitmap image (step 23), which in this example yields a 1920×1080×2 bit bitmap image;

dividing the uncompressed high-resolution bitmap image into blocks of n₁×n₂× . . . ×n_{N} pixels (step 24), whereby the size of each block correspond to the size of each pixel of the downscaled background image. In the preferred embodiment of the present invention, the JPEG background image is downscaled by a factor 2, whereby the HD uncompressed bitmap image is divided into blocks of 2×2 pixels and each of these blocks maps to exactly one pixel of the downscaled JPEG background image;

blending each of the blocks of the uncompressed high-resolution bitmap image with each of the pixels of the downscaled background image and thus producing a blended image (step 25), which in this example yields a 960×540×3×8 bit RGB image;

scaling the blended image further to desired SDTV size (step 26), such as 720×480 for NTSC or 720×576 for PAL.

In the preferred embodiment of the present invention, the downscaling of the HD JPEG background image is done in the DCT domain. However, there are other image representation domains which may be used, such as wavelet transform, Discrete Fourier Transform (DFT) etc, which all have the same advantages as the DCT domain, i.e. to downscale the compressed HD image before uncompressing it instead of first uncompressing the HD image and then downscaling it, which leads to reduced processing requirements and required image memory. Furthermore, for simplicity, in the preferred embodiment the HD JPEG background image is downscaled by a factor 2. It is, however, obvious for the person skilled in the art that any factor may be used. Downscaling in one direction is independent from the other directions, therefore, generally factor n₁, n₂, . . . n_{N} may be used for downscaling an N-dimensional image.

Although RGB is used in the preferred embodiment of the present invention, other color representations may be used, such as YUV, i.e. a luminance signal, generally referred to as Y, corresponds to the brightness information for the image and two chrominance signals, generally referred to as U and V, provide the color information. The invention does not depend on the color representation and works for mono-chrome, color, multi-spectral images and also three and higher dimensional images etc.

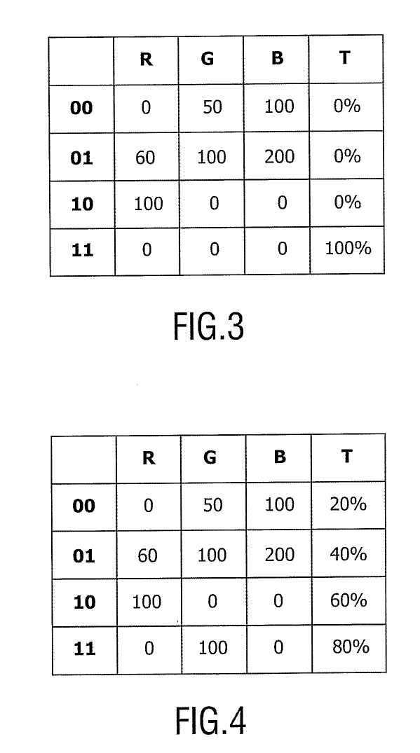

FIGS. 3 and 4 show examples of look-up tables showing the RGB values and transparency values T for each possible bitmap pixel value, when the bitmap image has 2 bit per pixel and each pixel within the bitmap image has a transparency value which can vary from pixel to pixel ranging from 0-100%, i.e. the degree of opacity of the bitmap pixels with 0% representing fully opaque and 100% representing transparent.

In case the transparency of all four pixels of a block is 100%, the output of step 25 in FIG. 2 for this block is simply the corresponding JPEG background pixel.

In case the transparency of all four pixels of a block is 0%, the output of step 25 in FIG. 2 for this block is, in the preferred embodiment of the present invention, the average of the four bitmap pixels after the look-up table operation of the bitmap image. In the following will be described an example of the output of step 25 in a specific block, where the four pixels have the bitmap values (0,0), (0,0), (0,1), (1,0). In this example, the average of the four bitmap pixels after using the look-up table of FIG. 3 is:
R=(0+0+60+100)/4=40
G=(50+50+100+0)/4=50
B=(100+100+200+0)/4=100
Thus, in this example, the output of step 25 of FIG. 2 for this specific block is (R, G, B)=(40, 50, 100).

In case the transparency of the four pixels of a block is different than for the two cases described above, i.e. more than 0% but less than 100%, a weighted average is computed instead of computing the average of the four bitmap pixels as described above. The weight factors are computed from the transparency values. Then, the weight-averaged bitmap pixels are blended with the corresponding JPEG background pixel using the average transparency. The transparency weighted average of the four bitmap pixels is:

$$( {R}_{w} , {G}_{w} , {B}_{w} ) = \frac{\{ \begin{matrix}\begin{matrix}( 1 - {T}_{1} ) \times ( {R}_{b 1} , {G}_{b 1} , {B}_{b 1} ) + \\ ( 1 - {T}_{2} ) \times ( {R}_{b 2} , {G}_{b 2} , {B}_{b 2} ) + \\ ( 1 - {T}_{3} ) \times ( {R}_{b 3} , {G}_{b 3} , {B}_{b 3} ) +\end{matrix} \\ ( 1 - {T}_{4} ) \times ( {R}_{b 4} , {G}_{b 4} , {B}_{b 4} )\end{matrix} \}}{\{ ( 1 - {T}_{1} ) + ( 1 - {T}_{2} ) + ( 1 - {T}_{3} ) + ( 1 - {T}_{4} ) \}}$$

The transparency of weight-averaged pixel (R_{w}, G_{w}, B_{w}) is:
T_{w}=(T₁+T₂+T₃+T₄)/4 (2)
The blended output pixel, i.e. the output of step 25 of FIG. 2 is:
(R₀, G₀, B₀)=(1−T_{w})×(R_{w}, G_{w}, B_{w})+T_{w}×(Rⱼ, Gⱼ, Bⱼ) (3)
wherein

(R₀, G₀, B₀)=output pixel of step 25 in FIG. 2;

(R_{w}, G_{w}, B_{w})=weight averaged pixel;

(R_{b1}, G_{b1}, B_{b1})=bitmap pixel 1 after LUT operation;

(Rⱼ, Gⱼ, Bⱼ)=corresponding pixel of downscaled JPEG background image;

T₁=transparency of bitmap pixel 1;

T_{w}=transparency of weight averaged pixel.

In the following will be described an example of the output of step 25 in a specific block, where the four pixels have the bitmap values (0,0), (0,1), (1,0), (1,1) and the corresponding downscaled JPEG background pixel is (Rⱼ, Gⱼ, Bⱼ)=(10, 20, 40). In this example, the weighted average of the four bitmap pixels is computed using the look-up table of FIG. 4 and equation (1):

$$\begin{matrix}( {R}_{w} , {G}_{w} , {B}_{w} ) = \frac{\{ \begin{matrix}( 1 - 0.2 ) \times ( 0 , 50 , 100 ) + \\ ( 1 - 0.4 ) \times ( 60 , 100 , 200 ) + \\ ( 1 - 0.6 ) \times ( 100 , 0 , 0 ) + \\ ( 1 - 0.8 ) \times ( 0 , 100 , 0 )\end{matrix} \}}{\{ ( 1 - 0.2 ) + ( 1 - 0.4 ) + ( 1 - 0.6 ) + ( 1 - 0.8 ) \}} \\ = \frac{\{ ( 0 , 40 , 80 ) + ( 36 , 60 , 120 ) + ( 40 , 0 , 0 ) + ( 0 , 20 , 0 ) \}}{2} \\ = ( 38 , 60 , 100 )\end{matrix}$$

the transparency of weight-averaged pixel (R_{w}, G_{w}, B_{w}) is computed using equation (2):
T_{w}={0.2+0.4+0.6+0.8}/4=0.5

And, the blended output pixel, i.e. output pixel of step 25 in FIG. 2, is computed using equation (3):
(R₀, G₀, B₀)=(1−0.5)×(38, 60, 100)+0.5×(10, 20, 40)=(24, 40, 70)

In an embodiment of the invention, the procedure for downscaling and blending a high-resolution compressed background image comprising pixels and a high-resolution compressed bitmap image comprising pixels and which is shown in FIG. 2, is implemented as a computer program product comprising software coded portions for performing the steps 21-26 when said product is run on a data-processing apparatus. The computer program product is preferably embodied on a computer-readable medium.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A device for downscaling and blending of a high-resolution compressed background image comprising pixels and a high-resolution compressed bitmap image comprising pixels, comprising:
means for downscaling the background image by a predetermined factor;
means for uncompressing the downscaled background image;
means for uncompressing the high-resolution bitmap image;
means for dividing the uncompressed high-resolution bitmap image into blocks of pixels, whereby the size of each block correspond to the size of each pixel of the downscaled background image; and
means for blending each of the blocks of the uncompressed high-resolution bitmap image with each of the pixels of the downscaled background image and thus producing a blended image.

2. A device according to claim 1, wherein the blending means is arranged to use at least one look-up table and combine the values of the pixels within the block of the uncompressed high-resolution bitmap image.

3. A device according to claim 1, wherein the scaling means is arranged to downscale the background image in the Discrete Cosine transform domain.

4. A method of downscaling and blending of a high-resolution compressed background image comprising pixels and a high-resolution compressed bitmap image comprising pixels, comprising the steps of:
downscaling the background image by a predetermined factor;
uncompressing the downscaled background image;
uncompressing the high-resolution bitmap image;
dividing the uncompressed high-resolution bitmap image into blocks of pixels, whereby the size of each block correspond to the size of each pixel of the downscaled background image; and
blending each of the blocks of the uncompressed high-resolution bitmap image with each of the pixels of the downscaled background image and thus producing a blended image.

5. A method according to claim 4, wherein the step of blending further comprises the step of combining the values of the pixels within the block of the uncompressed high-resolution bitmap image using at least one look-up table.

6. A method according to claim 4, wherein the step of downscaling the background image is done in the Discrete Cosine Transform domain.

7. A computer program, embodied in a computer-readable medium, for downscaling and blending a high-resolution compressed background image and a high-resolution compressed bitmap image, comprising:
downscaling the background image by a predetermined factor;
uncompressing the downscaled background image;
uncompressing the high-resolution bitmap image;
dividing the uncompressed high-resolution bitmap image into blocks of pixels, whereby the size of each block correspond to the size of each pixel of the downscaled background image; and
blending each of the blocks of the uncompressed high-resolution bitmap image with each of the pixels of the downscaled background image to produce a blended image.

8. (canceled)
